(19) United States
(12) Patent Application Publication
(10) Pub. No.: US 2016/0203803 A1
(43) Pub. Date: Jul. 14, 2016

(54) LESS-INVASIVE DRUM LUG

(71) Applicant: CREATION DRUM COMPANY, LLC, Rutherford, NJ (US)

(72) Inventor: Gregory Abrom, Rutherford, NJ (US)

(21) Appl. No.: 14/943,804

(22) Filed: Nov. 17, 2015

Related U.S. Application Data
(60) Provisional application No. 62/102,611, filed on Jan. 13, 2015.

(51) Int. Cl. G10D 13/02

(52) U.S. Cl. CPC G10D 13/023

(57) ABSTRACT

A novel drum lug and drum head anchor system. Conventional drum lugs place stress forces on a drum shell in undesired ways when drum heads are secured to drums using conventionally attached and conventionally shaped drum lugs. The novel drum lug and anchor system distributes the forces exerted by tension rods within the drum lug casing such that less force is translated to any anchor point or contact point on the drum shell. This may be accomplished by having a drum lug with an engagement post suited to engage a drum lug case with a similarly shaped engagement aperture. In one embodiment, the drum lug engages both a top and bottom drum lug casing simultaneously. This, in turn, tends to reduce or eliminate any stress or moment forces on the drum shell.

### PRIORITY CLAIM

This patent application claims priority to the U.S. Provisional Patent Application Ser. No. 62/102,611 entitled “DRUM LUG”, filed on Jan. 13, 2015, the entirety of which is incorporated herein by reference for all purposes.

### BACKGROUND

Drums are a category of musical instruments that produce percussive sounds when a musician strikes the drum with a stick, mallet, beater or even the musician's hands. Drums may be characterized as an enclosure or shell, typically cylindrically shaped, that has one or more drum heads stretched across one or more opening in the enclosure or shell. Long ago, such drum heads were made from animal skins or primitive paper products. Modern drum heads are often made from synthetic materials are more resilient and last longer. As a result, modern drum heads can also be tightened to precision so as to produce highly tunable percussive sounds as desired.

In order to have a tunable drum head, modern drums may have several fasteners that hold a drum ring over a drum head such that the drum head may be tightly stretched across an opening in a drum shell. These fasteners are called tension bolts (sometimes called lug bolts) and may be threaded at one end to engage with lug nuts that are secured to a side of a drum shell with lug castings (together sometimes called lugs). Thus, by tightening the tension bolts around the drum ring, the drum may be tuned to a desired sound, tone or pitch.

The lug castings, however, need to be anchored in a most secure manner to the drum shell. Thus, lug castings are often bolted directly to the drum shell such that the drum shell is penetrated at several locations around the outside. These penetrations may be undesirable as the tone, pitch and overall sound of the drum can become compromised by the lug castings. Conventional lug systems are too invasive for precision tuned drums.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 shows a diagram of a conventional drum with conventional drum lugs.

FIG. 2 is a side view of the drum of FIG. 1 of a conventional drum lug on the side of a conventional drum.

FIG. 3 is a cutaway view of the drum of FIG. 1 of a conventional drum lug on the side of a conventional drum.

FIG. 4 is an isometric view of a drum lug next to a drum lug casing according to an embodiment of the subject matter disclosed herein.

FIG. 5 is an isometric view of a drum lug engaged with a drum lug casing according to an embodiment of the subject matter disclosed herein.

FIG. 6 is an isometric view of a drum lug next to a set of top and bottom drum lug casings according to an embodiment of the subject matter disclosed herein.

FIG. 7 is an isometric view of a drum lug engaged with a set of top and bottom drum lug casings according to an embodiment of the subject matter disclosed herein.

FIG. 8 shows a diagram of a drum having drum lugs of FIGS. 4 and 5 according to an embodiment of the subject matter disclosed herein.

FIG. 9 is a side view of the drum of FIG. 8 showing a drum lug of FIGS. 4 and 5 according to an embodiment of the subject matter disclosed herein.

FIG. 10 is a cutaway view of the drum of FIG. 8 showing a drum lug of FIGS. 4 and 5 according to an embodiment of the subject matter disclosed herein.

FIG. 11 shows an isometric view of a drum having the drum lugs of FIGS. 6 and 7 according to an embodiment of the subject matter disclosed herein.

FIG. 12 shows various additional embodiments of various drum lugs according to embodiments of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

The subject matter disclosed herein is related to a novel drum lug and drum head anchor system. Conventional drum lugs place stress forces on a drum shell in undesired ways when drum heads are secured to drums using conventionally attached and conventionally shaped drum lugs. In various embodiment of the subject matter discussed herein, a novel drum lug distributes the forces exerted by tension rods within the drum lug casing such that less force is translated to any anchor point or contact point on the drum shell. This may be accomplished by having a drum lug with an engagement post suited to engage a drum lug case with a similarly shaped engagement aperture. In one embodiment, the drum lug engages both a top and bottom drum lug casing simultaneously. This, in turn, tends to reduce or eliminate any stress or moment forces on the drum shell. These and other aspects are better understood with respect to the detailed descriptions below in conjunction with FIGS. 1-12.

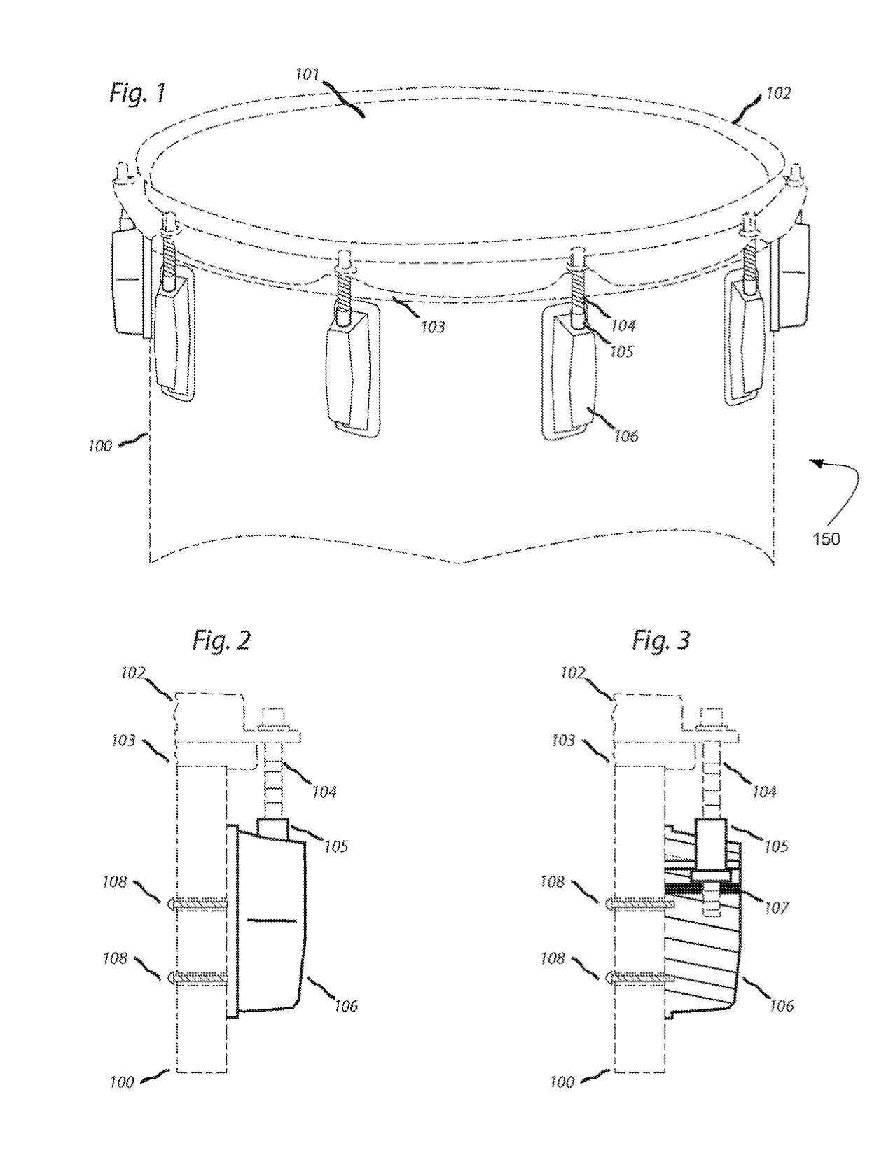

FIG. 1 shows a diagram of a conventional drum 150 with conventional drum lugs. A typical drum, as illustrated in this conventional drum 150 of FIG. 1 will have a drum head placed over a drum shell 100 wherein the drum head includes a batter head 101 encompassed by a drum head hoop 103. When engaged with a drum 150, the drum head hoop 103 may be held tightly in place over the drum 150 by a drum head ring 102. In the example shown in FIG. 1, the drum head ring 102 holds down the drum head hoop 103 such that the batter head 101 may be tightly held in place. The drum head ring 102 includes several eye holes for placing bolts (typically called tension rods 104, a term used hereinafter). Thus, around the edge of the drum head ring 103, several tension rods 104 may be used to engage several drum lugs 106 by threading the tensions rods into a lug nut 105 encased in the drum lug 106. The drum lugs 106 may be secured to the drum shell 100 in conventional ways as discussed next with respect to FIGS. 2 and 3.

FIG. 2 is a side view of the drum 150 of FIG. 1 of a conventional drum lug 106 on the side of a conventional drum shell 100. In this side view, one can see the tension bolt 104 threaded through one eyelet of the drum head ring 102 such that the drum head hoop 103 is help below the plane of the drum head ring 102. Further, the tension rod 104 is engaged with a lug nut 108 encased within the elongated drum lug 106. By turning the tension rod 104 (using a wrench-like drum key (not shown)), one can raise or lower the drum head hoop in this local area of the drum head. Therefore, a musician may tune the drum head (e.g., reaching a uniform and desired tension throughout the drum head so as to produce a pleasing sound) by tightening or loosening each tension rod 104 on the drum to a desired level.

In this conventional drum 150, the drum lugs are attached to the drum shell using two (or more) lug anchors 108. The lug anchors 108 penetrate the drum shell 100 and secure the drum lug 106 to the outside of the drum shell. By anchoring the drum lugs 106 tightly to the outside of the drum shell 100, the tension rods have a relatively immovable anchor point by which to engage the lug nut 105 in each drum lug 106. Any penetration in the drum shell may be undesired as anomalies may be introduced that affect the overall tone and sound of the drum itself. That is, a well-designed drum will be uniform enough in shape to produce a pure tone at one frequency when struck. As anomalies are invariably introduced, the pure tone becomes muddied by differing overtones and harmonics produced by small differences in the drum shell shape. That is, as more and more penetrations are introduced, more and more anomalies in the drum shell detract from the desired pure tone to be produced when struck. Further, the drum shell 100 itself may warp over time when using these conventional drum lugs 106 as discussed next with respect to FIG. 3.

FIG. 3 is a cutaway view of the drum 150 of FIG. 1 of a conventional drum lug 107 on the side of a conventional drum shell 100. In this cutaway view, one can see inside the drum lug 106 where the drum lug anchors 108 attach. Because there are two drum lug anchors 108 within the drum lug, a moment force is created inside the drum lug 106 at the point 107. As the tension rod 104 is tightened, a force is increased that pulls the drum head hoop 103 and drum head ring 102 down. An equal force pulls up on the drum lug 106. This upward force is then transferred to the drum anchors 108 holding the drum lug to the drum shell 100. Because the two drum lug anchors 108 are vertically offset, more of the vertical force holding down the drum head ring 102 is transferred to the bottom drum lug anchor than the top drum lug anchor. The difference in transferred force creates a moment force that tends to rotate the drum lug 106 in a counter-clockwise manner with respect to orientation shown in FIG. 3. That is, the drum lug tends to push into the drum shell 100 at point 107 and pull out from the drum shell 100 at the drum lug anchors 108. This moment force, over time tends to warp the drum shell 100, which then leads to additional anomalies affecting the tone and sound of the drum. These and other anomalies may be reduced or eliminated by using the novel drum lugs as described in the remainder of this disclosure.

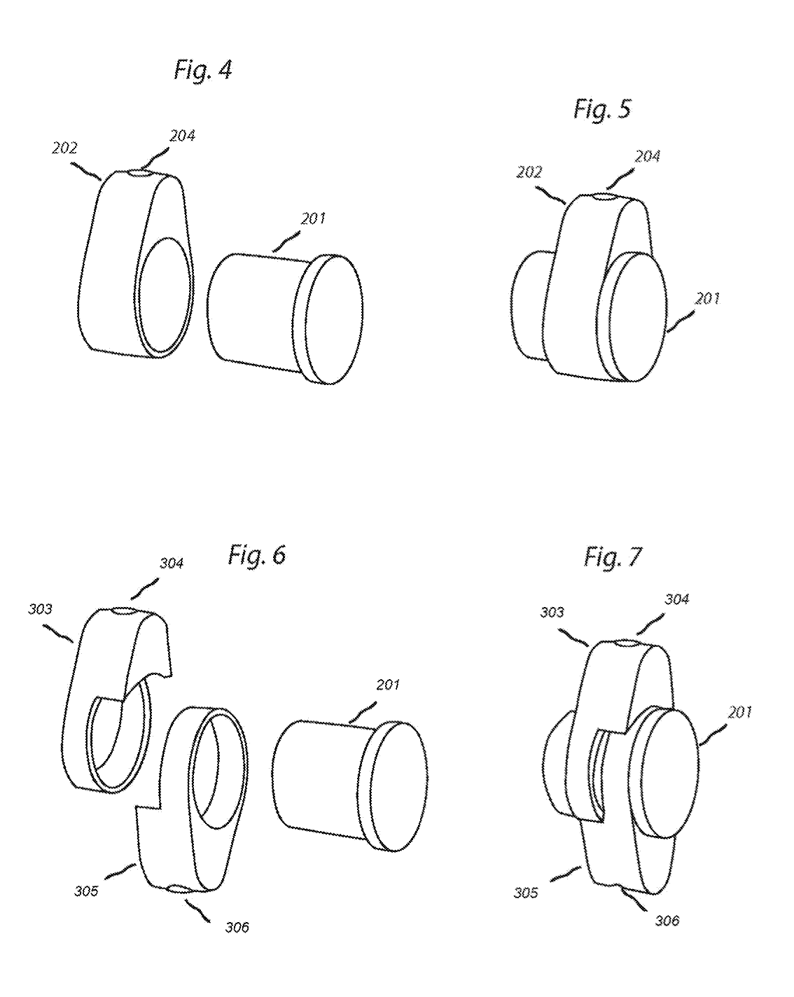

FIG. 4 is an isometric view of a drum lug 201 next to a drum lug casing 202 according to an embodiment of the subject matter disclosed herein. The drum lug 201 includes a cylindrical body section having a lip protruding beyond the circumference of the cylindrical body on one side. The cylindrical body may be referred to as an engagement post. The cylindrical body of the drum lug 201 is sized to engage with a cylindrical engagement hole (e.g., an engagement aperture) in the matched drum lug casing 202. Thus, the engagement post of the drum lug 201 may be slidably engaged and disengaged with the engagement hole of the drum lug casing 202. Further the drum lug casing comprises an oblong cylindrical shape that includes an amalgamation of two cylinders. A first cylindrical shape having a larger diameter (e.g., the major diameter of the amalgamated cylinders) that houses the drum lug hole and a second cylindrical shape having a smaller diameter (e.g., the minor diameter of the amalgamated cylinders). In this embodiment, an integral drum lug nut 204 is disposed on a top side (the side of the minor diameter cylinder facing away from the major diameter cylinder) of the drum lug casing 202. A tension rod (not shown) is configured to rotatably engage the drum lug nut 204.

FIG. 5 is an isometric view of the drum lug 201 of FIG. 4 engaged with the drum lug casing 202 of FIG. 4 according to an embodiment of the subject matter disclosed herein. When engaged, a tension rod (not shown) that exerts a force upward on the drum lug casing 202 (e.g., the tension rod is holding down a drum head rim that holds a drum head over the drum shell). Different from conventional drum lug casings, the force exerted by the tension rod is not translated into as much of a moment force of the drum lug as these forces tend to spread out across the cylindrical diameter of the drum lug 201. The drum lug 201 may still be anchored to the drum shell at one central point (as shown below with respect to FIG. 8), but the amount of force translated to the anchor bolt is less because of the shape of the drum lug 201 and the manner in which the drum lug casing 202 engages with the drum lug 201 and the cylindrical opening of the drum lug casing 202. Exerting less of a moment force at the anchor bolt footing of the drum lug 201 is advantageous over conventional drum lug solutions. These forces may be reduced further by including a second drum lug casing engaged with the same drum lug as discussed next with respect to FIGS. 6 and 7.

FIG. 6 is an isometric view of a drum lug 201 next to a set of top 303 and bottom 305 drum lug casings according to an embodiment of the subject matter disclosed herein. As discussed above, the drum lug 201 includes a cylindrical body section having a lip protruding beyond the circumference of the cylindrical body on one side. The cylindrical body may be referred to as an engagement post. The cylindrical body of the drum lug 201 is sized to engage with a cylindrical engagement hole in the matched set of drum lug casings 303 and 305. Thus, the engagement post of the drum lug 201 may be slidably engaged and disengaged with the engagement hole of the top-side drum lug casing 303 as well as the bottom-side drum lug casing 305.

In this embodiment, the set of drum lug casings 303 and 305 each comprise an oblong cylindrical shape that includes an amalgamation of two cylinders. A first cylindrical shape having a larger diameter (e.g., the major diameter of the amalgamated cylinders) that houses the drum lug engagement hole and a second cylindrical shape having a smaller diameter (e.g., the minor diameter of the amalgamated cylinders). In this embodiment, a first integral drum lug nut 304 is disposed on a top side (the side of the minor diameter cylinder facing away from the major diameter cylinder) of the top-side drum lug casing 303. A first tension rod (not shown) is configured to rotatably engage the drum lug nut 304. Additionally, a second integral drum lug nut 306 is disposed on a top side (the side of the minor diameter cylinder facing away from the major diameter cylinder) of the bottom-side drum lug casing 305. A second tension rod (not shown) is configured to rotatably engage the drum lug nut 304.

In this embodiment, the top-side drum lug casing 303 and the bottom-side drum lug casing 305 are contoured to be fitted together when engaged with the engagement post of the drum lug 201. This is achieved by designing the major diameter cylinder in each drum casing 303 and 305 to have a shorter width than minor diameter cylinder. In this manner, the top-side drum casing and the bottom side drum casing may be fit together as shown in FIG. 7.

FIG. 7 is an isometric view of a drum lug 201 engaged with a set of top 303 and bottom 305 drum lug casings according to an embodiment of the subject matter disclosed herein. When engaged, a first tension rod (not shown) exerts a force upward on the drum lug casing 303 (e.g., the first tension rod is holding down a top-side drum head rim that holds a batter head over the top-side opening of the drum shell). Further, a second tension rod (not shown) exerts a force downward on the drum lug casing 305 (e.g., the second tension rod is holding down a bottom-side drum head rim that holds a reverb head over the bottom-side opening of the drum shell). As before, different from conventional drum lug casings, the forces exerted by the tension rods is not translated into as much of a moment force of the drum lug 201 as these forces tend to spread out across the cylindrical diameter of the drum lug 201. The drum lug 201 may still be anchored to the drum shell at one central point (as shown below with respect to FIG. 8), but the amount of force translated to the anchor bolt is less because of the shape of the drum lug 201 and the manner in which the drum lug casing 202 engages with the drum lug 201 and the cylindrical opening of the drum lug casing 202. Further, in this embodiment, the force exerted by the top-side tension rod may cancel out against the force exerted by the bottom-side tension rod. This may result in no moment force whatsoever being exerted on the drum shell. Exerting less of a moment force (or even no moment force) at the anchor bolt footing of the drum lug 201 is advantageous over conventional drum lug solutions. These and other concepts are further discussed below with respect to FIGS. 8-11.

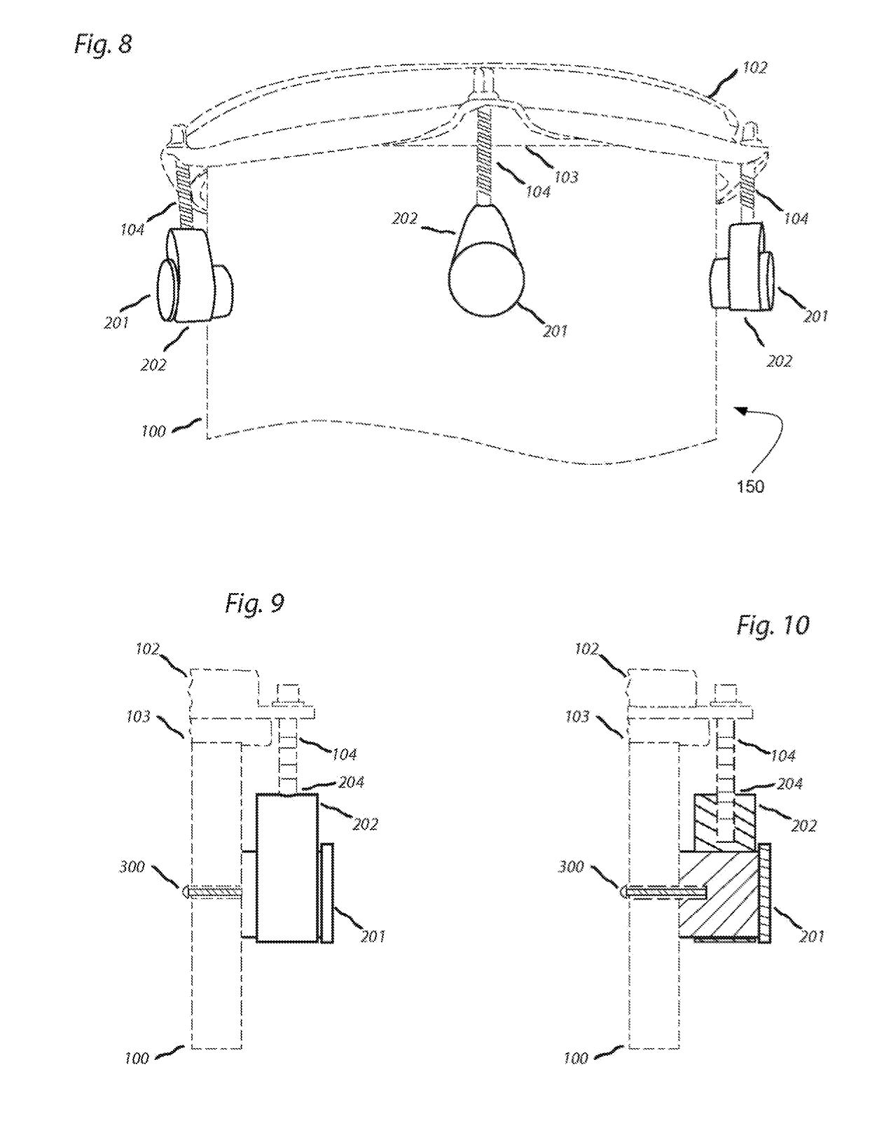

FIG. 8 shows a diagram of a drum 150 having drum lugs of FIGS. 4 and 5 according to an embodiment of the subject matter disclosed herein. A typical drum, as illustrated in the drum 150 of FIG. 8 will have a drum head placed over a drum shell 100 wherein the drum head includes a batter head (not shown) encompassed by a drum head hoop 103. When engaged with the drum 150, the drum head hoop 103 may be held tightly in place over the drum 150 by a drum head ring 102. In the example shown in FIG. 8, the drum head ring 102 holds down the drum head hoop 103 such that the batter head may be tightly held in place. The drum head ring 102 includes several eye holes for placing tension rods 104. Thus, around the edge of the drum head ring 103, several tension rods 104 may be used to engage several drum lugs casings 202 by threading the tensions rods into a drum lug nut integral with the drum lug casings 202 106. The drum lugs casings may be slidably and removably engaged with drum lugs 201 that may be secured to the drum shell 100 with a single anchor (not shown) as discussed with respect to FIGS. 9 and 10.

FIG. 9 is a side view of the drum of FIG. 8 showing a drum lug of FIGS. 4 and 5 according to an embodiment of the subject matter disclosed herein. In this side view, one can see the tension bolt 104 threaded through one eyelet of the drum head ring 102 such that the drum head hoop 103 is help below the plane of the drum head ring 102. Further, the tension rod 104 is engaged with a drum casing nut 204 encased within the drum lug casing 202. By turning the tension rod 104 (using a drum key (not shown)), one can raise or lower the drum head hoop 103 in this local area of the drum head. Therefore, a musician may tune the drum head (e.g., reaching a uniform and desired tension throughout the drum head so as to produce a pleasing sound) by tightening or loosening each tension rod 104 on the drum to a desired level.

In this embodiment of the novel drum 150, the drum lug 201 is attached to the drum shell 100 using a lug anchor 300. The lug anchor 300 penetrates the drum shell 100 and secures the drum lug 201 to the outside of the drum shell 100. By anchoring the drum lug 201 tightly to the outside of the drum shell 100, the tension rods have a relatively immovable anchor point by which to engage the lug nut 204 in each drum lug casing 202.

FIG. 10 is a cutaway view of the drum of FIG. 8 showing a drum lug of FIGS. 4 and 5 according to an embodiment of the subject matter disclosed herein. In this cutaway view, one can see inside the drum lug 202 where the drum lug anchor 300 attaches. As the tension rod 104 is tightened, a force is increased that pulls the drum head hoop 103 and drum head ring 102 down. An equal force pulls up on the drum lug nut 204. This upward force is then transferred to the drum lug casing 202 engagement hole and then spread across the engagement post of the drum lug 201. The drum lug 201 is held in place by the anchor 300, but some of the force is relieved through the circumference of the drum lug 201 that touches the drum shell 100 to the drum anchors 108 holding the drum lug to the drum shell 100. This results in less of a moment force at the anchor point than conventional drum lugs (as shown in FIGS. 1-3).

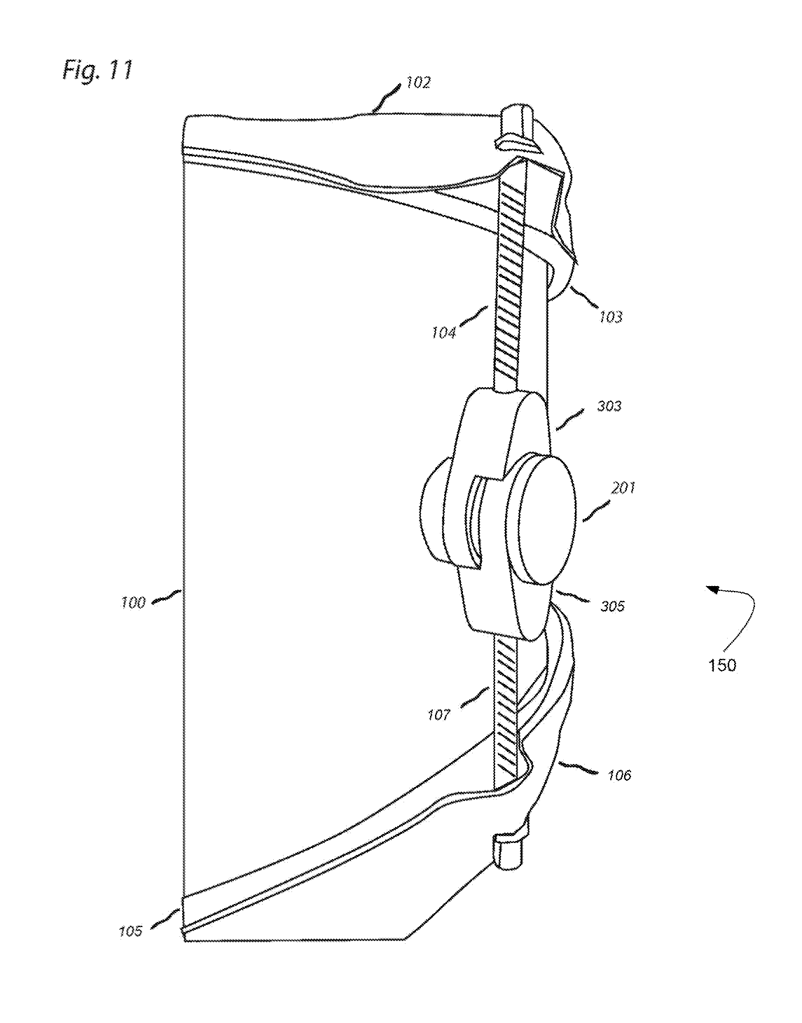

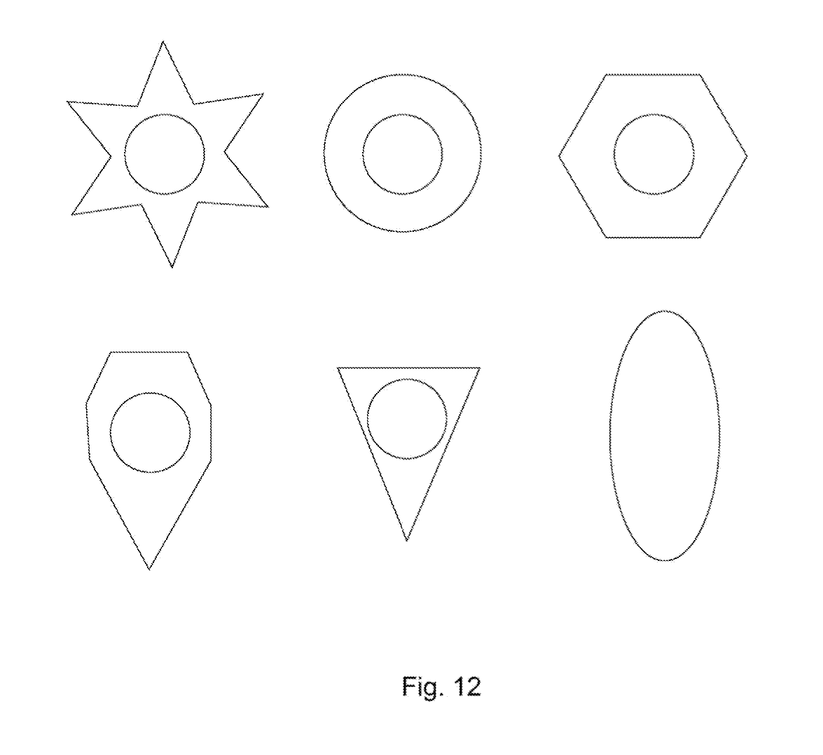

FIG. 11 shows an isometric view of a drum 150 having the drum lugs 201 of FIGS. 6 and 7 according to an embodiment of the subject matter disclosed herein. A typical drum, as illustrated in the drum 150 of FIG. 11 again will have a drum head placed over a drum shell 100 wherein the drum head includes a batter head (not shown) encompassed by a drum head hoop 103. When engaged with the drum 150, the drum head hoop 103 may be held tightly in place over the drum 150 by a drum head ring 102. In the example shown in FIG. 11, the drum head ring 102 holds down the drum head hoop 103 such that the batter head may be tightly held in place. In this embodiment, a second drum head (bottom-side reverberation head) may be placed over the bottom side opening of the drum shell 100 wherein the bottom side drum head includes its own drum head hoop 105. When engaged with the drum 150, this drum head hoop 105 may be held tightly in place over the drum 150 by a second drum head ring 106. In the example shown in FIG. 11, the drum head ring 106 holds down the drum head hoop 105 such that the batter head may be tightly held in place.

Each drum head ring 102 and 106 includes several eye holes for placing tension rods 104 and 107. Thus, around the edge of the top and bottom drum head rings 103 and 105, several tension rods 104 and 107 may be used to engage several drum lugs casings 303 and 305 by threading the tensions rods into a drum lug nut integral with the drum lug casings 303 and 305. The drum lugs casings 303 and 305 may be slidably and removably engaged with drum lugs 201.

In this embodiment of the novel drum 150, the drum lug 201 is not attached in any manner to the drum shell 100. That is, because the forces exerted by the top-side tension rod 104 and the bottom side tension rod 107 tend to cancel each other out and the drum lug 201 is simply held in place at an equilibrium point. Such an anchor system then requires no penetrations to the drum shell for anchoring drum lugs 201. This results in zero possibility of warping a drum shell 100 due to drum lug 104 and 107 tension or drum lug moment forces.

FIG. 12 shows various additional embodiments of various drum lug casings according to embodiments of the subject matter disclosed herein. These additional drum lug casings may suitably engage with a cylindrical drum lug engagement post as described previously. The additional embodiment shapes include a star-shaped drum lug casing, a circular drum lug casing, a hexagonal drum lug casing, a conical polygon drum lug casing, an isosceles triangle drum lug casing, and an oval drum lug casing.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A drum head anchor system, comprising:
a drum lug having an engagement post;
a drum lug casing configured to slidably and removably engage the engagement post at an engagement aperture; and
a tension rod configured to rotatably engage the drum lug casing at a drum lug nut integral with the drum lug casing.

2. The drum lug anchor system of claim 1, wherein the engagement post of the drum lug comprises a cylindrical shape flanked by a cylindrical lip.

3. The drum lug anchor system of claim 1, wherein the drum lug casing further comprises an amalgamated-cylinders shape having a first portion having a major diameter and a second portion having a minor diameter.

4. The drum lug anchor system of claim 3, wherein the first portion further comprises the engagement aperture.

5. The drum lug anchor system of claim 1, wherein the drum lug casing further comprises a threaded drum lug nut configured to rotatably engage a the tension rod that further comprises threads suited to match the drum lug nut.

6. The drum lug anchor system of claim 1, further comprising:
a second drum lug casing configured to slidably and removably engage the engagement post at a second engagement aperture; and
a second tension rod configured to rotatably engage the second drum lug casing at a second drum lug nut integral with the second drum lug casing.

7. The drum lug anchor system of claim 6, wherein the second drum lug casing further comprises an amalgamated-cylinders shape having a first portion having a major diameter and a second portion having a minor diameter.

8. The drum lug anchor system of claim 6, wherein the second drum lug casing further comprises an amalgamated-cylinders shape having a first portion having a major diameter and a first width and a second portion having a minor diameter and second width greater than the first width.

9. The drum lug anchor system of claim 1, wherein the drum lug casing comprises a shape from a group comprised of: a star-shaped drum lug casing, a circular drum lug casing, a hexagonal drum lug casing, a conical polygon drum lug casing, an isosceles triangle drum lug casing, and an oval drum lug casing.

10. A drum, comprising:
a drum shell;
a batter head disposed over the drum shell;
a drum head ring disposed over the batter head;
a plurality of drum lugs, each having a respective engagement post;
a plurality of drum lug casings, each configured to slidably and removably engage one of the plurality of engagement posts at a respective engagement aperture; and
a plurality of tension rods respectively threaded through a plurality of eye holes disposed around a circumference of the drum head ring, each tension rod configured to rotatably engage a respective one of the plurality of drum lug casings at a respective drum lug nut integral with the respective drum lug casing.

11. The drum of claim 10, wherein the plurality of tension rods may be maneuvered to increase or decrease tension in the batter head.

12. The drum of claim 10, wherein each of the plurality of drum lugs are respectively anchored to the drum shell with a respective single anchor.

13. The drum of claim 10, wherein the plurality of drum lugs comprises ten drum lugs.

14. The drum of claim 10, further comprising:
a second drum head disposed over the drum shell opposite the first drum head;
a second drum head ring disposed over the second drum head;
a plurality of second-head drum lug casings, each configured to slidably and removably engage one of the plurality of engagement posts of the plurality of drum lugs at a respective engagement aperture; and
a plurality of second-head tension rods respectively threaded through a plurality of eye holes disposed around a circumference of the second drum head ring, each second-head tension rod configured to rotatably engage a respective one of the plurality of second head drum lug casings at a respective drum lug nut integral with the respective second-head drum lug casing.

15. The drum of claim 14, wherein the plurality of second-head tension rods may be maneuvered to increase or decrease tension in the second drum head.

16. The drum of claim 14, wherein force exerted on each of the plurality of drum lugs by a respective second-head tension rod is approximately equal to the force exerted on each of the plurality of drum lugs by a respective tension rod associated with the batter head.

17. A drum lug, comprising:
a first portion having an engagement post; and
a second portion configured to slidably and removably engage the engagement post at an engagement aperture, the engagement aperture having a shape that matches a shape of the engagement post.

18. The drum lug of claim 17, wherein the first portion further comprises a lip integral with the engagement post having a dimension greater than the engagement post.

19. The drum lug of claim 17, wherein the shape of the engagement post comprises a cylinder.

20. The drum lug of claim 17, wherein second portion further comprises an amalgamated-cylinders shape having a first section having a major diameter and a second section having a minor diameter, such that the major section further comprises the engagement aperture and the minor section further comprises a tension rod engagement aperture.
